(19) United States
(12) Patent Application Publication
(10) Pub. No.: US 2021/0259912 A1
(43) Pub. Date: Aug. 26, 2021

(54) SPORTS MASSAGE DEVICE FOR RELIEVING MUSCLE SORENESS AFTER EXERCISING AND EXERCISE APPARATUS

(71) Applicant: KA CHUN FAN, Hong Kong (CN)

(72) Inventor: KA CHUN FAN, Hong Kong (CN)

(21) Appl. No.: 17/105,665

(22) Filed: Nov. 27, 2020

(30) Foreign Application Priority Data
Feb. 25, 2020 (CN) 202010114591.0

(51) Int. Cl. A61H 23/00; A61H 23/02

(52) U.S. Cl. CPC A61H 23/004; A61H 23/02; A61H 23/006

(57) ABSTRACT

The disclosure discloses a sports massage device for relieving muscle soreness after exercising and an exercise apparatus, and relates to a technical field of fitness machine. The device includes a massage device and a mount. The massage device includes a housing, a rubber pad, a bulge, an iron cylinder, a second spring, a magnet and a cable. The housing is connected to the mount, an opening cover of the housing is provided with the rubber pad, the bulge is connected with an upper end of the rubber pad, the iron cylinder is connected within the housing, the iron cylinder, the second spring, the magnet and the rubber pad are sequentially connected, and the cable is used for connecting with an alternating current power supply and is wound around the iron cylinder, so that the iron cylinder generates magnetism to drive the magnet to vibrate when the cable is electrified.

### TECHNICAL FIELD

The disclosure relates to a technical field of fitness machine, in particular to a sports massage device for relieving muscle soreness after exercising and an exercise apparatus.

### BACKGROUND ART

With improvement of people's living, it has become a way of life to keep healthy through sports, and people often go to fitness places for physical exercise.

After exercising, people will feel soreness in muscles, and generally a massage is needed at an exercise site to relieve the muscle soreness. The existing sports massage device for relieving muscle soreness after exercising is complex in structure and requires human participation.

In view of this, it is particularly important to develop and design a sports massage device for relieving muscle soreness after exercising and an exercise apparatus, which can solve the above-mentioned problems.

### SUMMARY

An object of the present disclosure is to provide a sports massage device for relieving muscle soreness after exercising, which has characteristics of simple structure and no need for human participation.

Another object of the present disclosure is to provide an exercising apparatus, which has characteristics of simple structure, no need for human participation, and has a massage function and a hand stretching function.

The disclosure provides a technical scheme as follows.

In a first aspect, an embodiment of the disclosure provides a sports massage device for relieving muscle soreness after exercising, which includes a massage device and a mount. The massage device includes a housing, a rubber pad, a bulge, an iron cylinder, a second spring, a magnet and a cable. The housing is connected to the mount, an opening cover of the housing is provided with the rubber pad, the bulge is connected with an upper end of the rubber pad, the iron cylinder is connected within the housing, the iron cylinder, the second spring, the magnet and the rubber pad are sequentially connected, and the cable is used for connecting with an alternating current power supply and is wound around the iron cylinder, so that the iron cylinder generates magnetism to drive the magnet to vibrate when the cable is electrified.

Combined with the first aspect, in a first implementation of the first aspect, the massage device further includes a switch and an indicator light. The switch and the indicator light are both connected to an outer surface of the housing, and are both arranged on the cable.

Combined with the first aspect and the above implementation, in a second implementation of the first aspect, a top end surface of the bulge is provided in a hemispherical shape, and the bulge is made of an elastic material.

In a second aspect, an embodiment of the disclosure also provides an exercise apparatus including the sports massage device for relieving muscle soreness after exercising described above, and the exercise apparatus further includes a stretching device. The stretching device includes a support frame, a guide cylinder, a pull rod, a third spring, a carriage, a guide rod, a link and a grip. The support frame is connected with the mount and is connected with a telescopic rod. A right end of the support frame is connected with the guide cylinder, the pull rod is slidably sleeved inside the guide cylinder, and the third spring is sleeved on an outer side of the pull rod and is connected with the pull rod and an inner wall of the guide cylinder respectively. A right end of the pull rod is connected with the carriage which is connected with the link, and a lower end of the link is connected with the grip, which is used for an operator to hold and can move along a length direction of the guide rod.

Combined with the second aspect, in a first implementation of the second aspect, the stretching device further includes a case, a threaded rod and a friction block. A right end of the carriage is connected with the case, the case is threadedly connected with the threaded rod, and the threaded rod is also connected with the friction block, so that a pressure applied by the friction block on an outer side of the guide rod can be adjusted by rotating the threaded rod.

Combined with the second aspect and the above implementation, in a second implementation of the second aspect, the stretching device further includes a sliding plate, a support rod and a fourth spring. A lower end of the threaded rod is closely attached to the sliding plate which is slidably connected to the case, the support rod is movably sleeved inside the sliding plate, the fourth spring is sleeved on an outer side of the support rod, and the friction block is connected to the lower end of the support rod, so that the support rod is pressed by the fourth spring, and then the friction block is pressed.

Combined with the second aspect and the above implementations, in a third implementation of the second aspect, the stretching device further includes a turntable and a handle. An upper end of the threaded rod is connected with the turntable and an upper end of the turntable is connected with the handle.

Combined with the second aspect and the above implementations, in a fourth implementation of the second aspect, the exercise apparatus further includes a telescopic device. The telescopic device includes a support cylinder telescopic rod, a positioning rod and a cylinder. The mount includes a lying plate, the housing is connected to the lying plate, and the support frame is connected with the lying plate through the telescopic rod and the support cylinder. An upper end of the lying plate is connected with the support cylinder, the telescopic rod is slidably sleeved inside the support cylinder, a left end of the support cylinder is connected with the cylinder, the positioning rod is slidably sleeved inside the cylinder, a positioning groove is provided on the telescopic rod, and the positioning rod can be clamped in the positioning groove, so that a position of the telescopic rod relative to the support cylinder can be locked.

Combined with the second aspect and the above implementations, in a fifth implementation of the second aspect, the telescopic device further includes the cylinder and a first spring. The support cylinder is connected with the cylinder, the positioning rod is slidably sleeved inside the cylinder, the first spring is sleeved on an outer side of the positioning rod, and the first spring elastically presses the positioning rod in the positioning groove.

Combined with the second aspect and the above implementations, in a sixth implementation of the second aspect, the mount further includes a base, a damping shaft and a support post. A lower end of the lying plate is hinged with the support post through the damping shaft, and the support post is connected with the base.

Compared with the prior art, the sports massage device for relieving muscle soreness after exercising and the exercise apparatus provided in embodiments of the disclosure has the following beneficial effects:

The massage device includes the housing, the rubber pad, the bulge, the iron cylinder, the second spring, the magnet and the cable. The housing is connected to the mount, the opening cover of the housing is provided with the rubber pad, the bulge is connected with the upper end of the rubber pad, the iron cylinder is connected within the housing, the iron cylinder, the second spring, the magnet and the rubber pad are sequentially connected, and the cable is used for connecting with an alternating current power supply and is wound around the iron cylinder. In this way, the iron cylinder generates magnetism to drive the magnet to vibrate when the cable is electrified and the second spring pulls the magnet to reset, which thus forms a reciprocating vibration. Then the magnet drives the bulge to vibrate and the bulge acts on an exercise site to achieve a massage effect. Therefore, the sports massage device for relieving muscle soreness after exercising is simple in structure and does not require human participation.

In order to make the above objects, features and advantages of the present disclosure more obvious and easy to understand, a detailed description will be made below to the preferred embodiments in conjunction with the drawings.

### BRIEF DESCRIPTION OF DRAWINGS

In order to explain technical schemes of the embodiments of the present disclosure more clearly, the drawings used in the embodiment will be briefly introduced below. It should be understood that the following drawings only illustrate certain embodiments of the present disclosure, and therefore should not be regarded as limiting the scope thereof. For those skilled in the art, other related drawings can be obtained according to these drawings without paying any creative labor.

FIG. 1 is a structural view of a sports massage device for relieving muscle soreness after exercising provided in a first embodiment of the present disclosure.

FIG. 2 is a cross-sectional structural view of a sports massage device for relieving muscle soreness after exercising provided in the first embodiment of the present disclosure.

FIG. 3 is a circuit diagram of a sports massage device for relieving muscle soreness after exercising provided in the first embodiment of the present disclosure.

FIG. 4 is a structural view of an exercise apparatus provided in a second embodiment of the present disclosure.

FIG. 5 is an enlarged structural view at a in FIG. 4.

FIG. 6 is a cross-sectional structural view of a part of a stretching device of the exercise apparatus provided in the second embodiment of the present disclosure.

Reference Number: 1—Base; 2—Telescopic Device; 5—Mount; 21—Lying Plate; 22—Support Cylinder; 23—Fan; 24—Telescopic Rod; 25—Positioning Groove; 26—Positioning Rod; 27—Cylinder; 28—First Spring; 29—Damping Shaft; 210—Support Post; 3—Massage Device; 31—Housing; 32—Switch; 33—Indicator Light; 34—Rubber Pad; 35—Bulge; 36—Iron Cylinder; 37—Second Spring; 38—Magnet; 4—Stretching Device; 41—Support Frame; 42—Guide Cylinder; 43—Pull Rod; 44—Third Spring; 45—Slide; 46—Guide Rod; 47—Case; 48—Threaded Rod; 49—Turntable; 410—Handle; 411—sliding plate; 412—Support Rod; 413—Fourth Spring; 414—Friction Block; 415—Link; 416—Grip; 39—Cable.

### DETAILED DESCRIPTION OF PREFERRED EMBODIMENTS

In order to make the objects, technical schemes and advantages of the embodiments of the present disclosure more clear, the technical schemes in the embodiments of the present disclosure will be described clearly and completely in combination with the drawings in the embodiments of the present disclosure. Obviously, the described embodiments are some, but not all, of the embodiments of the present disclosure. Generally, components of the embodiments of the present disclosure described and illustrated in the drawings herein may be arranged and designed in various different configurations.

It should be noted that similar reference numbers and letters indicate similar items in the following figures, and thus once an item is defined in one figure, it is not necessary to further define and explain it in the following figures. Orientations or positional relationships indicated by the terms “upper”, “lower”, “inner”, “outer”, “left” and “right” or the like are based on orientations or positional relationships shown in the drawings, or orientations or positional relationships that a product of the present disclosure are usually placed in use, or orientations or positional relationships that are commonly understood by those skilled in the art, which is only for convenience of describing the present disclosure and for simplifying the description, but is not intended to indicate or imply that the referenced apparatus or element must be in a particular orientation, configured or operated in a particular orientation, and thus should not to be construed as limiting the present disclosure. The terms “first”, “second”, etc. are only used to distinguish descriptions, and cannot be understood as indicating or implying a relative importance. Terms “comprising”, “including” or any other variation thereof are intended to encompass a non-exclusive inclusion, so that a process, method, article or apparatus including a series of elements includes not only those elements, but also other elements not explicitly listed, or elements inherent to such process, method, article or apparatus. Without further restrictions, an element defined by the statement “includes a . . . ” does not exclude presence of other identical elements in the process, method, article or apparatus including the element.

It should also be noted that unless otherwise specified and limited, terms such as “providing” and “connecting” should be understood in a broad sense. For example, “connecting” can be a connection, a detachable connection, or an integral connection; or can be a mechanical or electrical connection; or can be a direct connection, or an indirect connection through an intermediate medium, or can be a communication inside two elements. For a person of ordinary skill in the art, specific meanings of the above terms in the present disclosure can be understood according to specific situations.

The specific embodiments of the present disclosure will be described in detail in combination with the drawings.

### First Embodiment

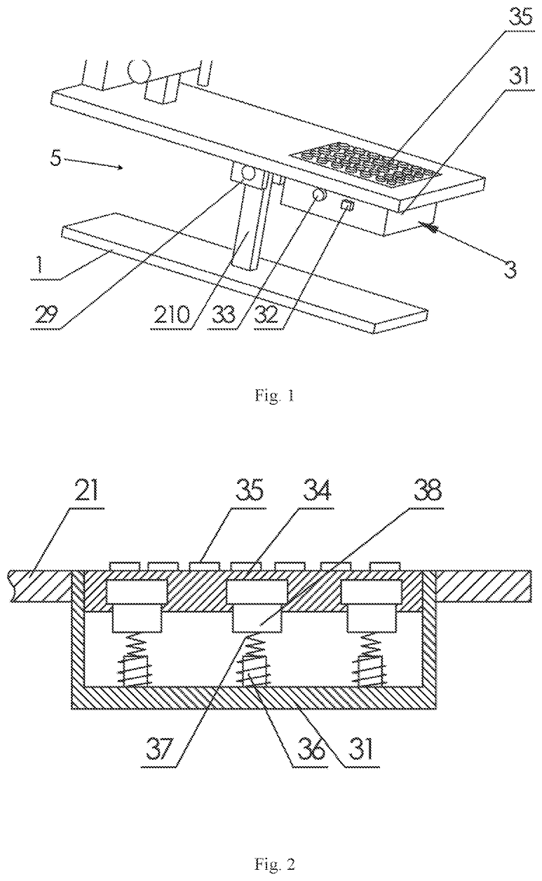

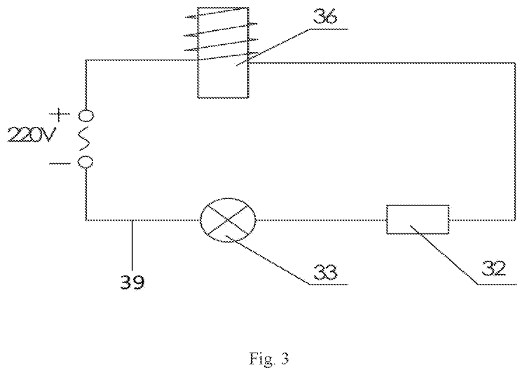

Please refer to FIGS. 1, 2 and 3, FIG. 1 is a structural view of a sports massage device 3 for relieving muscle soreness after exercising provided in a first embodiment of the present disclosure. FIG. 2 is a cross-sectional structural view of a sports massage device 3 for relieving muscle soreness after exercising provided in the first embodiment of the present disclosure. FIG. 3 is a circuit diagram of a sports massage device 3 for relieving muscle soreness after exercising provided in the first embodiment of the present disclosure.

The first embodiment of the present disclosure provides a sports massage device 3 for relieving muscle soreness after exercising, which has characteristics of simple structure and no need for human participation. The sports massage device 3 for relieving muscle soreness after exercising can be applied to various sports equipment. Of course, the sports massage device 3 for relieving muscle soreness after exercising can also be used independently.

A structure constitute, a working principle and beneficial effects of the sports massage device 3 for relieving muscle soreness after exercising provided in the embodiment of the present disclosure will be specifically introduced in the following.

The sports massage device 3 for relieving muscle soreness after exercising includes a massage device 3 and a mount 5. The massage device 3 includes a housing 31, a rubber pad 34, a bulge 35, an iron cylinder 36, a second spring 37, a magnet 38 and a cable 39. The housing 31 is connected to the mount 5, an opening cover of the housing 31 is provided with the rubber pad 34, the bulge 35 is connected with an upper end of the rubber pad 34, the iron cylinder 36 is connected within the housing 31, the iron cylinder 36, the second spring 37, the magnet 38 and the rubber pad 34 are sequentially connected, and the cable 39 is used for connecting with an alternating current power supply and is wound around the iron cylinder 36.

In this way, the iron cylinder 36 generates magnetism to drive the magnet 38 to vibrate when the cable 39 is electrified and the second spring 37 pulls the magnet 38 to reset, which thus forms a reciprocating vibration. Then the magnet 38 drives the bulge 35 to vibrate and the bulge 35 acts on an exercise site to achieve a massage effect. Therefore, the sports massage device 3 for relieving muscle soreness after exercising is simple in structure and does not require human participation.

Furthermore, the massage device 3 further includes a switch 32 and an indicator light 33. The switch 32 and the indicator light 33 are both connected to an outer surface of the housing 31, and are both arranged on the cable 39. The switch 32 acts to turn on or off the sports massage device 3 for relieving muscle soreness after exercising, and the indicator light 33 is used to indicate whether the sports massage device 3 for relieving muscle soreness after exercising is in on or off state.

Furthermore, a top end surface of the bulge 35 is provided in a hemispherical shape to improve the massage effect, and the bulge 35 is made of an elastic material which can be the soft rubber pad 34 such as a silicone gel rubber pad 34 or a silicone rubber pad 34.

The working principle of the sports massage device 3 for relieving muscle soreness after exercising provided in the first embodiment of the present disclosure is as follows:

The massage device 3 includes the housing 31, the rubber pad 34, the bulge 35, the iron cylinder 36, the second spring 37, the magnet 38 and the cable 39. The housing 31 is connected to the mount 5, the opening cover of the housing 31 is provided with the rubber pad 34, the bulge 35 is connected with the upper end of the rubber pad 34, the iron cylinder 36 is connected within the housing 31, the iron cylinder 36, the second spring 37, the magnet 38 and the rubber pad 34 are sequentially connected, and the cable 39 is used for connecting with an alternating current power supply and is wound around the iron cylinder 36. In this way, the iron cylinder 36 generates magnetism to drive the magnet 38 to vibrate when the cable 39 is electrified and the second spring 37 pulls the magnet 38 to reset, which thus forms a reciprocating vibration. Then the magnet 38 drives the bulge 35 to vibrate and the bulge 35 acts on an exercise site to achieve a massage effect. Therefore, the sports massage device 3 for relieving muscle soreness after exercising is simple in structure and does not require human participation.

To sum up:

The first embodiment of the present disclosure provides a sports massage device 3 for relieving muscle soreness after exercising, which has characteristics of simple structure and no need for human participation.

### Second Embodiment

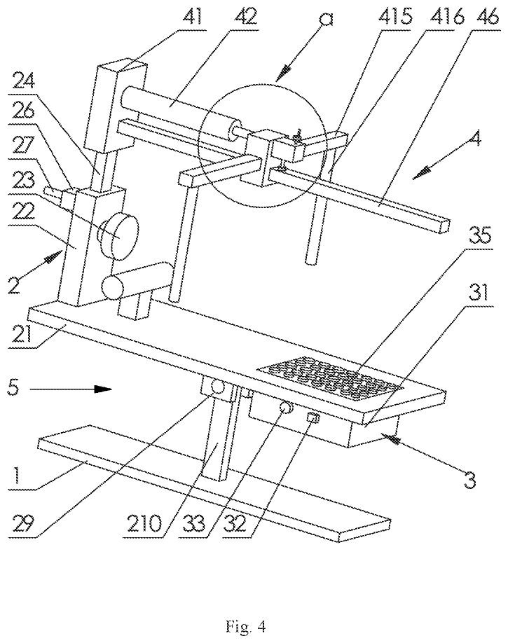

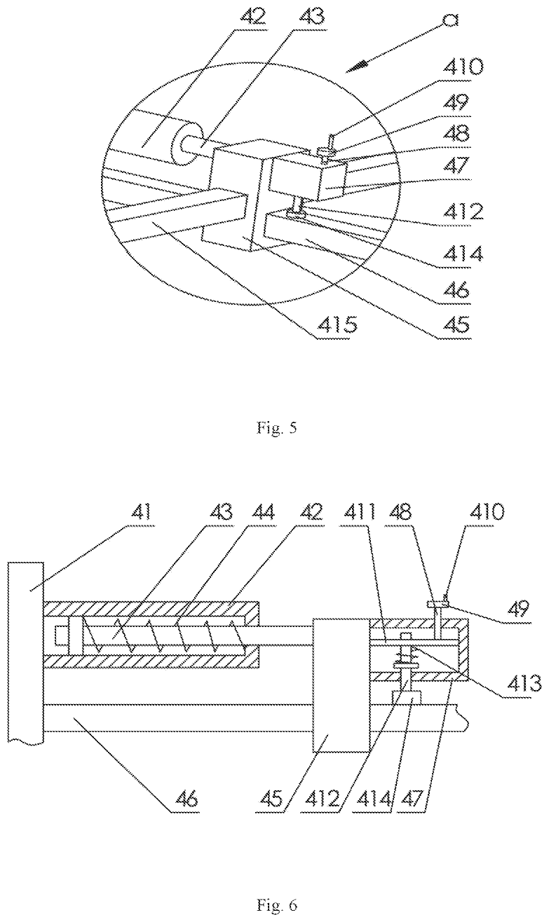

Please refer to FIGS. 4, 5 and 6, FIG. 4 is a structural view of an exercise apparatus provided in the second embodiment of the present disclosure. FIG. 5 is an enlarged structural view at a in FIG. 4. FIG. 6 is a cross-sectional structural view of a part of a stretching device 4 of the exercise apparatus provided in the second embodiment of the present disclosure.

Firstly, it should be noted that the exercise apparatus provided in this embodiment includes the sports massage device 3 for relieving muscle soreness after exercising described in the above embodiment, and its basic principle and technical effects are the same as those in the above embodiments, and for brief description, reference can be made to corresponding parts in the above embodiments for those not mentioned in this embodiment.

The exercise apparatus further includes a stretching device 4. The stretching device 4 includes a support frame 41, a guide cylinder 42, a pull rod 43, a third spring 44, a carriage 45, a guide rod 46, a link 415 and a grip 416.

The support frame 41 is connected with the mount 5 and is connected with a telescopic rod 24. A right end of the support frame 41 is connected with the guide cylinder 42, the pull rod 43 is slidably sleeved inside the guide cylinder 42, and the third spring 44 is sleeved on an outer side of the pull rod 43 and is connected with the pull rod 43 and an inner wall of the guide cylinder 42 respectively. A right end of the pull rod 43 is connected with the carriage 45 which is connected with the link 415, and a lower end of the link 415 is connected with the grip 416, which is used for an operator to hold and can move along a length direction of the guide rod 46 so that the user can perform a stretching exercise on the hand. In addition, an exercise site can be massaged by a sports massage device 3 for relieving muscle soreness after exercising, which increases exercise items and avoid singleness in exercising function.

Further, the stretching device 4 may further include a case 47, a threaded rod 48 and a friction block 414. A right end of the slide 45 is connected with the case 47, the case 47 is threadedly connected with the threaded rod 48, and the threaded rod 48 is also connected with the friction block 414, so that a pressure applied by the friction block 414 on an outer side of the guide rod 46 can be adjusted by rotating the threaded rod 48. When it is necessary to increase an intensity of the stretching exercise, it can be achieved by adjusting friction resistance between the friction block 414 and the guide rod 46.

Further, the stretching device 4 further includes a sliding plate 411, a support rod 412 and a fourth spring 413. A lower end of the threaded rod 48 is closely attached to the sliding plate 411 which is slidably connected to the case 47, the support rod 412 is movably sleeved inside the sliding plate 411, the fourth spring 413 is sleeved on an outer side of the support rod 412, and the friction block 414 is connected to the lower end of the support rod 412, so that the support rod 412 is pressed by the fourth spring 413, and then the friction block 414 is pressed, and in this way, an accuracy of adjusting the friction resistance between the friction block 414 and the guide rod 46 is improved.

Further, the stretching device 4 further includes a turntable 49 and a handle 410. An upper end of the threaded rod 48 is connected with the turntable 49 and an upper end of the turntable 49 is connected with the handle 410, and in this way an adjustment by the user is facilitated.

Further, the exercise apparatus further includes a telescopic device 2. The telescopic device 2 includes a support cylinder 22 telescopic rod 24, a positioning rod 26 and a cylinder 27. The mount 5 includes a lying plate 21, the housing 31 is connected to the lying plate 21, and the support frame 41 is connected with the lying plate 21 through the telescopic rod 24 and the support cylinder 22. An upper end of the lying plate 21 is connected with the support cylinder 22, the telescopic rod 24 is slidably sleeved inside the support cylinder 22, a left end of the support cylinder 22 is connected with the cylinder 27, the positioning rod 26 is slidably sleeved inside the cylinder 27, a positioning groove 25 is provided on the telescopic rod 24, and the positioning rod 26 can be clamped in the positioning groove 25, so that a position of the telescopic rod 24 relative to the support cylinder 22 can be locked, and in this way a height of the grip 416 can be adjusted and adapted to users of different sizes.

Further, the telescopic device 2 further includes the cylinder 27 and a first spring 28. The support cylinder 22 is connected with the cylinder 27, the positioning rod 26 is slidably sleeved inside the cylinder 27, the first spring 28 is sleeved on an outer side of the positioning rod 26, and the first spring 28 elastically presses the positioning rod 26 in the positioning groove 25. this way, it can be ensured by the first spring 28 that the positioning rod 26 is stably clamped in the positioning groove 25, thus stably locking a position of the telescopic rod 24 relative to the support cylinder 22.

Further, the mount 5 further includes a base 1, a damping shaft 29 and a support post 210. The support post 210 is connected with the base 1. A lower end of the lying plate 21 is hinged with the support post 210 through the damping shaft 29. In this way, an orientation of the lying plate 21 can be adjusted.

Generally speaking, in this embodiment, the mount 5 includes the lying plate 21, the base 1, the damping shaft 29 and the support post 210. The support post 210 is connected with the base 1, while the lower end of the lying plate 21 is hinged with the support post 210 through the damping shaft 29. An upper end of the base 1 is fixedly connected with the telescopic device 2 and the telescopic device 2 is fixedly connected with the massage device 3, and an upper end of the telescopic device 2 is fixedly connected with the stretching device 4. The telescopic device 2 includes the support cylinder 22, the fan 23, the telescopic rod 24, the positioning groove 25, the positioning rod 26, the cylinder 27, the first spring 28 and the damping shaft 29. The upper end of the lying plate 21 is fixedly connected with the support cylinder 22, and the right end of the support cylinder 22 is fixedly connected with the fan 23. The telescopic rod 24 is slidably sleeved inside the support cylinder 22, and the left end of the support cylinder 22 is fixedly connected with the cylinder 27. The positioning rod 26 is slidably sleeved inside the cylinder 27, and the lower end of the lying plate 21 is hinged with the support post 210 through the damping shaft 29, and the support post 210 is fixedly connected with the base 1. The massage device 3 includes the housing 31, the switch 32, the indicator light 33, the silicone gel pad 34. the bulge 35, the iron cylinder 36, the second spring 37 and the magnet 38. The housing 31 is fixedly embedded with the lying plate 21, the silicone gel pad 34 is fixedly connected within the housing 31 and the upper end of the silicone gel pad 34 is fixedly connected with the bulge 35. The iron cylinder 36 is fixedly connected within the housing 31, the upper end of the iron cylinder 36 is fixedly connected with the second spring 37, the upper end of the second spring 37 is fixedly connected with the magnet 38, and the magnet 38 is fixedly embedded with the silicone gel pad 34. The stretching device 4 includes the support frame 41, the guide cylinder 42, the pull rod 43, the third spring 44, the carriage 45, the guide rod 46, the case 47, the threaded rod 48, the turntable 49, the handle 410, the sliding plate 411, the support rod 412, the fourth spring 413, the friction block 414, the link 415 and the grip 416. The support frame 41 is fixedly connected with the telescopic rod 24, and the right end of the support frame 41 is fixedly connected with the guide cylinder 42. The pull rod 43 is slidably sleeved inside the guide cylinder 42, and the third spring 44 is slidably sleeved on the outer side of the pull rod 43. The right end of the pull rod 43 is fixedly connected with the carriage 45, and the right end of the carriage 45 is fixedly connected with the case 47. The case 47 is threadedly connected with the threaded rod 48, and the lower end of the threaded rod 48 is closely attached to the sliding plate 411, the sliding plate 411 is slidably connected with the case 47, the support rod 412 is slidably sleeved inside the sliding plate 411, the fourth spring 413 is sleeved on the outer side of the support rod 412, and the lower end of the support rod 412 is fixedly connected with the friction block 414.

The working principle of the exercise apparatus provided in the second embodiment of the present disclosure is as follows.

The exercise apparatus further includes the stretching device 4. The stretching device 4 includes the support frame 41, the guide cylinder 42, the pull rod 43, the third spring 44, the carriage 45, the guide rod 46, the link 415 and the grip 416. The support frame 41 is connected with the mount 5 and is connected with a telescopic rod 24. A right end of the support frame 41 is connected with the guide cylinder 42, the pull rod 43 is slidably sleeved inside the guide cylinder 42, and the third spring 44 is sleeved on an outer side of the pull rod 43 and is connected with the pull rod 43 and an inner wall of the guide cylinder 42 respectively. A right end of the pull rod 43 is connected with the carriage 45 which is connected with the link 415, and a lower end of the link 415 is connected with the grip 416, which is used for an operator to hold and can move along a length direction of the guide rod 46 so that the user can perform a stretching exercise on the hand. In addition, an exercise site can be massaged by a sports massage device 3 for relieving muscle soreness after exercising, which increases exercise items and avoid singleness in exercising function.

To sum up:

The second embodiment of the present disclosure provides an exercise apparatus, which has the characteristics of the sports massage device 3 for relieving muscle soreness after exercising described above, and also has the hand stretching function.

The above is only preferred embodiments of the present disclosure, and is not intended to limit the present disclosure. For those skilled in the art, the features in the above embodiments can be combined with each other and modification and variations can be made to the present disclosure without conflict.

1. A sports massage device for relieving muscle soreness after exercising, comprising a massage device (3) and a mount (5);
The massage device (3) comprises a housing (31), a rubber pad (34), a bulge (35), an iron cylinder (36), a second spring (37), a magnet (38) and a cable (39); wherein
the housing (31) is connected to the mount (5), an opening cover of the housing (31) is provided with the rubber pad (34), the bulge (35) is connected with an upper end of the rubber pad (34), the iron cylinder (36) is connected within the housing (31), the iron cylinder (36), the second spring (37), the magnet (38) and the rubber pad (34) are sequentially connected, and the cable (39) is used for connecting with an alternating current power supply and is wound around the iron cylinder (36), so that the iron cylinder (36) generates magnetism to drive the magnet (38) to vibrate when the cable (39) is electrified.

2. The sports massage device for relieving muscle soreness after exercising according to claim 1, wherein the massage device (3) further comprises a switch (32) and an indicator light (33); wherein
the switch (32) and the indicator light (33) are both connected to an outer surface of the housing (31), and are both arranged on the cable (39).

3. The sports massage device for relieving muscle soreness after exercising according to claim 1, wherein a top surface of the bulge (35) is provided in a hemispherical shape, and the bulge (35) is made of an elastic material.

4. An exercise apparatus, comprising the sports massage device (3) for relieving muscle soreness after exercising according to claim 1, the exercise apparatus further comprising a stretching device (4); wherein
the stretching device (4) comprises a support frame (41), a guide cylinder (42), a pull rod (43), a third spring (44), a carriage (45), a guide rod (46), a link (415) and a grip (416); and
the support frame (41) is connected with the mount (5) and is connected with a telescopic rod (24), a right end of the support frame (41) is connected with the guide cylinder (42), the pull rod (43) is slidably sleeved inside the guide cylinder (42), and the third spring (44) is sleeved on an outer side of the pull rod (43) and is connected with the pull rod (43) and an inner wall of the guide cylinder (42) respectively, and a right end of the pull rod (43) is connected with the carriage (15) which is connected with the link (415), and a lower end of the link (415) is connected with the grip (416), which is used for an operator to hold and is capable of moving along a length direction of the guide rod (46).

5. The exercise apparatus according to claim 4, wherein the stretching device (4) further comprises a case (47), a threaded rod (48) and a friction block (414); wherein
a right end of the carriage (45) is connected with the case (47), the case (47) is threadedly connected with the threaded rod (48), and the threaded rod (48) is also connected with the friction block (414), so that a pressure applied by the friction block (414) on an outer side of the guide rod (46) is adjusted by rotating the threaded rod (48).

6. The exercise apparatus according to claim 5, wherein the stretching device (4) further comprises a sliding plate (411), a support rod (412) and a fourth spring (413); wherein
a lower end of the threaded rod (48) is closely attached to the sliding plate (411) which is slidably connected to the case (47), the support rod (412) is movably sleeved inside the sliding plate (411), the fourth spring (413) is sleeved on an outer side of the support rod (412), and the friction block (414) is connected to the lower end of the support rod, so that the support rod (412) is pressed by the fourth spring (413), and then the friction block (414) is pressed.

7. The exercise apparatus according to claim 5, wherein the stretching device (4) further comprises a turntable (49) and a handle (410); wherein
an upper end of the threaded rod (48) is connected with a turntable (49) and an upper end of the turntable (49) is connected with the handle (410).

8. The exercise apparatus according to claim 4, wherein the exercise apparatus further comprises a telescopic device (2); wherein
the telescopic device (2) comprises a support cylinder (24) telescopic rod (22), a positioning rod (26) and a cylinder (27);
the mount (5) comprises a lying plate (21), the housing (31) is connected to the lying plate (21), and the support frame (41) is connected with the lying plate (21) through the telescopic rod (24) and the support cylinder (22); and
an upper end of the lying plate (21) is connected with the support cylinder (22), the telescopic rod (24) is slidably sleeved inside the support cylinder (22), a left end of the support cylinder (22) is connected with the cylinder (27), the positioning rod (26) is slidably sleeved inside the cylinder (27), a positioning groove (25) is provided on the telescopic rod (24), and the positioning rod (26) can be clamped in the positioning groove (25), so that a position of the telescopic rod (24) relative to the support cylinder (22) can be locked.

9. The exercise apparatus according to claim 8, wherein the telescopic device (2) further comprises a cylinder (27) and a first spring (28); wherein
the support cylinder (22) is connected with the cylinder (27), the positioning rod (26) is slidably sleeved inside the cylinder (27), the first spring (28) is sleeved on an outer side of the positioning rod (26), and the first spring (28) elastically presses the positioning rod (26) in the positioning groove (25).

10. The exercise apparatus according to claim 8, wherein the mount (5) further comprises a base (1), a damping shaft (29) and a support post (210); wherein
a lower end of the lying plate (21) is hinged with the support post (210) through the damping shaft (29), and the support post (210) is connected with the base (1).
